(19) United States
(12) Patent Application Publication
(10) Pub. No.: US 2011/0037009 A1
(43) Pub. Date: Feb. 17, 2011

(54) NON-RETURN VALVE

(75) Inventors: Roland Svensson, Bro (SE); Victor Carlsson, Sundbyberg (SE); Martin Larsson, Sundbyberg (SE)

Correspondence Address: RATNERPRESTIA, P.O. BOX 980, VALLEY FORGE, PA, 19482, US

(73) Assignee: ITT Manufacturing Enterprises Inc., Wilmington, DE (US)

(21) Appl. No.: 12/668,048

(22) PCT Filed: Jul. 7, 2008
(86) PCT No.: PCT/SE2008/050841

§ 371 Date: Oct. 29, 2010

(30) Foreign Application Priority Data
Jul. 9, 2007 (SE) 0701656-1

(51) Int. Cl. F16K 15/02

(52) U.S. Cl. 251/324

(57) ABSTRACT

The present invention relates to a non-return valve for a liquid piping system, comprising a valve housing and a valve member, which is movable between a first position, in which a flow path is blocked, and a second position, in which the flow path is un-blocked. The non-return valve comprises a non-return valve attachment comprising a housing, a piston assembly and an energy storing means, the piston assembly being axially movable in relation to said housing between a first active position, and a second position. In said second position the fluid pressure of said liquid drives the piston assembly against the action of the energy storing means away from said first position, such that the valve member is movable into said second position of the valve member.

### TECHNICAL FIELD OF THE INVENTION

The present invention relates generally to the field of non-return valves for piping systems for liquid. Further, the present invention relates specifically to the field of non-return valves for waste water piping system. The non-return valve comprises a valve housing and a valve member, which valve housing defines a flow path for a liquid, the valve member being movable under the effect of the flow of said liquid between a first position, in which the flow path is blocked and a liquid flow in a first direction is prevented, and a second position, in which the flow path is unblocked and a liquid flow in an opposite second direction is admitted, the non-return valve being equipped with a non-return valve attachment comprising a housing, a piston assembly, and an energy storing means, the piston assembly being axially movable in relation to said housing between a first position and a second position.

### BACKGROUND OF THE INVENTION

Within domestic and/or industrial areas several properties are connected to a common piping system for waste water. Each property or group of properties has an individual pipe extending from a sump or pump station to a main pipe, and each individual pipe is equipped with a non-return valve. The function of the non-return valves, when the pump that is connected to the individual pipe is turn off, is to prevent that the entire content of the main pipe and the piping system flows back through the individual pipe to the sump or pump station in which the turned off pump is located.

Conventional non-return valves are associated with a great drawback in the form of water hammering. Upon closure of a conventional non-return valve, due to the turning off of the pump, certain inertia is present in the piping system or the individual pipe. When the pump is turned off the liquid flow continues for a relatively long period of time in the pumped liquid flow direction, due to said inertia and that the valve member is controlled by the flow of the liquid. When the liquid flow stops the valve member is position at a distance from the valve seat, and before the valve member has managed to close the non-return valve, the liquid flow is reversed and the liquid flow obtains a velocity towards the pump and sump. Thus, the entire liquid volume present in the pipe between the pump and the non-return valve as well as between the pump and the sump, has a considerable kinetic energy at the time when the non-return valve is finally closed. Due to the kinetic energy a vacuum pocket is established between the valve member of the non-return valve and the reversed liquid flow. The vacuum pocket again reverses the liquid flow and when the liquid flow rushes towards the non-return valve so called water hammering will occur when the valve member is hit by the liquid flow and temporarily pushed away from contact with the valve seat and thereafter again slammed into contact with the valve seat by the liquid volume present downstreams of the non-return valve. Thus, this phenomenon will bring about large variations of pressure, and even small variations of pressure are sufficient to fatigue the pipes, bring about external wearing of the pipes against adjacent objects due to movements in the piping system, and as well sufficient for pipes to implode and joints to burst due to the slowness of the non-return valve. Conventional non-return valves comprise a valve member in the form of a flap that is pivotally arranged around an axis and moveable between a open position and a closed position, or a ball that is movable between an open position and a closed position.

A conventional way of trying to obtain a more rapid non-return valve is to force the valve member towards the closed position thereof, in order to get a quick response when the pump is turned off. The ball may be filled with lead or the flap may be equipped with a lever, or the valve element may be pushed towards the closed position by a spring mechanism, or loaded in any other way. Even if a more rapid response is obtained, it is not necessarily rapid enough and thereto a worse problem arises, more precisely that the pump during operation all the time must overcome the additional resistance from the flap, ball, or spring which is energy consuming.

### SUMMARY OF THE INVENTION

The present invention aims at obviating the aforementioned disadvantages of previously known non-return valves, and at providing an improved non-return valve. A primary object of the present invention is to provide an improved non-return valve of the initially defined type that is rapid and that does not bring about additional resistance. It is another object of the present invention to provide a non-return valve, which prevents water hammering.

According to the invention at least the primary object is attained by means of the initially defined non-return valve having the features defined in the independent claims. Preferred embodiments of the present invention are further defined in the dependent claims.

According to the present invention, there is provided a non-return valve of the initially defined type, which is characterized in that the piston assembly, in said first position, under the action of the energy storing means overcomes the fluid pressure of said liquid and drives the valve member towards said first position of the valve member, and in said second position the fluid pressure of said liquid drives the piston assembly against the action of the energy storing means away from said first position of the piston assembly, such that the valve member is movable into said second position of the valve member.

Thus, the present invention is based on the insight that the liquid pressure of the pumped liquid drops much more rapid than the flow direction of the liquid is reversed. By controlling the closure of the non-return valve by means of the liquid pressure instead of the flow direction of the liquid a more rapid response of the non-return valve will be obtained.

In a preferred embodiment of the present invention, the valve member is biased into said first position of the valve member, by means of the piston assembly positioned in said first position of the piston assembly, under the action of the energy storing means. This means that, when the pump is turned off, the valve member will be forced towards the closed position with a much higher force than conventional loaded valve members, and will close the non-return valve just before or at the same time as the liquid flow reverses, more precisely the liquid flow upstreams of the non-return valve does not reverse but stops.

According to a preferred embodiment the piston assembly comprises a piston and a rod, the latter extending from said piston away from said cavity and towards the valve member.

According to a preferred embodiment the energy storing means is a spring having an adjustable action, in order to be suitable for different applications.

### BRIEF DESCRIPTION OF THE DRAWINGS

A more complete understanding of the abovementioned and other features and advantages of the present invention will be apparent from the other dependent claims as well as from the following detailed description of preferred embodiments in conjunction with the appended drawings, wherein:

FIG. 1 is a schematic cross sectional side view of an inventive non-return ball valve having the ball valve member and the piston assembly in their respective second positions,

FIG. 2 is a schematic cross sectional side view of the inventive non-return ball valve according to FIG. 1 having the ball valve member and the piston assembly in their respective first positions,

FIG. 3 is schematic cross sectional side view of an inventive non-return flap valve having the flap valve member and the piston assembly in their respective second positions,

FIG. 4 is a schematic cross sectional side view of the inventive non-return flap valve according to FIG. 3 having the flap valve member and the piston assembly in their respective first positions, and

FIG. 5 is a schematic cross sectional side view of an alternative embodiment of the inventive non-return valve.

### DETAILED DESCRIPTION OF PREFERRED EMBODIMENTS OF THE INVENTION

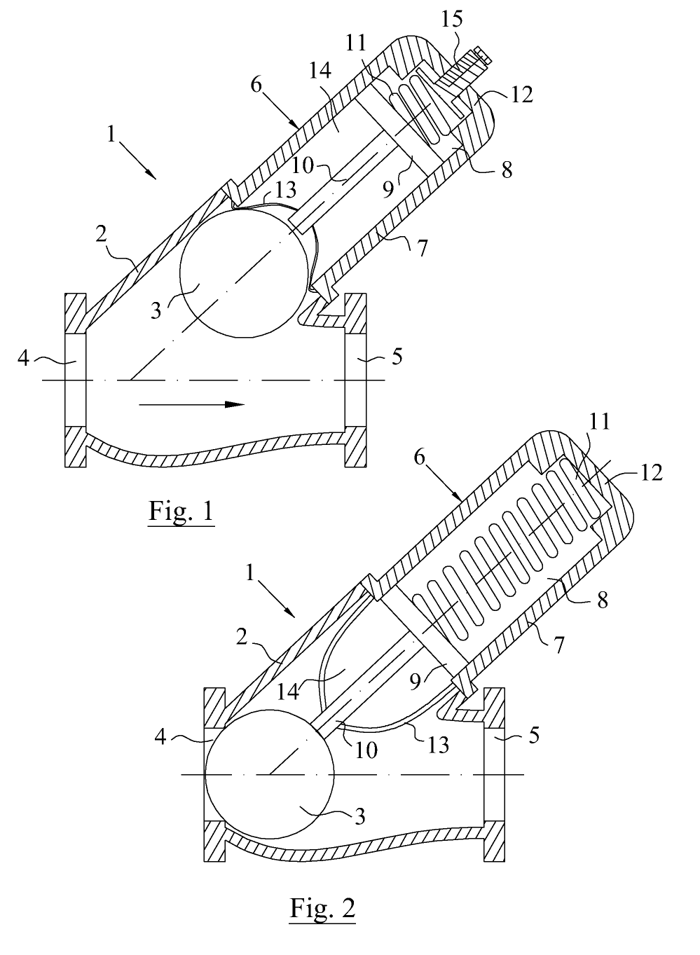

Reference is initially made to FIGS. 1 and 2, which shows a first embodiment of the inventive non-return valve 1. The non-return valve 1 comprises a valve housing 2 and a valve member 3. The valve housing 2 defines a flow path for the liquid, which is pumped in the direction of the arrow shown in FIG. 1 by a pump (not shown). Preferably the non-return valve 1 and the pump are part of a waste water piping system (not shown). The pump is connected to the inlet opening 4 of the non-return valve 1, by any suitable pipe (not shown) e.g. an outlet pipe, and another suitable pipe (not shown) is connected to the outlet opening 5 of the non-return valve 1, and may extend to a main pipe (not shown) of the piping system. In the shown embodiment according to FIGS. 1 and 2, the valve member 3 is constituted by a ball, which is freely movable between a first position, in which the flow path in the valve housing 2 is blocked according to FIG. 2 and a liquid flow in a first direction is prevented, and a second position, in which said flow path is unblocked according to FIG. 1 and a liquid flow in a second direction is admitted. It shall be pointed out that the non-return valve 1 comprises guide means (not shown) for the ball valve member 3, such that the ball valve member 3 does not obstruct the outlet opening 5 of the non-return valve 1 when the pump is in operation, but is guided into said second position of the valve member 3.

In a conventional non-return valve the valve member is displaced under the effected of the flow of the liquid present in the piping system. When the pump is activated the ball valve member will thus leave the first position and will be displaced under the effect of the flow of the liquid into said second position, and when the pump is turned off the ball valve member 3 will return to the first position due to the effect of the reversed flow of the liquid. According to the inventive non-return valve 1 the valve member 3 will be displaced from the first position to the second position under the effect of the flow of the liquid when the pump is activated. However, the return movement of the valve member 3 will in the preferred embodiment of the present invention not be effected at all by the flow of the liquid, as will be described hereinafter.

The ball valve member 3 may be constituted by an aluminum casing filled with sand and coated with a protecting rubber sleeve if the non-return ball valve 1 is oriented according to FIGS. 1 and 2, or may be constituted by an aluminum casing filled with air and coated with a protecting rubber sleeve if the non-return ball valve 1 is oriented having the second position of the valve member 3 located below the first position of the valve member 3.

Moreover, the non-return valve 1 comprises a non-return valve attachment 6 located adjacent to the second position of the valve member 3, covering an opening in the valve housing 2, through which opening the valve member 3 may be inserted and removed from the non-return valve 1. The non-return valve attachment 6 may be bolted to the valve housing 2, alternatively the non-return valve attachment 6 may be screwed into the valve housing 2, or attached to the valve housing 2 in any other suitable way.

The non-return valve attachment 6 comprises a housing 7, preferably elongated, in which a piston assembly is arranged, the housing 7 and piston assembly defining a cavity 8. The piston assembly comprises in the preferred embodiment a piston 9 and a rod 10, the latter extending from said piston 9 away from said cavity 8 and towards the valve member 3. The rod 10 is preferably oriented in parallel with the axial extension of the housing 7 of the non-return valve attachment 6. Furthermore, the piston 9 and the rod 10 are jointly movable back and forth within the housing 7 between a first position according to FIG. 2 and a second position according to FIG. 1. The periphery of the piston 9 is in liquid sealing engagement with the inner wall surface of the housing 7 of the non-return valve attachment 6.

Moreover, the non-return valve attachment 6 comprises an energy storing means 11 preferably accommodated in the cavity 8 defined by the housing 7 of the non-return valve attachment 6 and the piston 9. Preferably, the energy storing means 11 is constituted by a compression spring, which is schematically shown in the figures. However, the energy storing means 11 may be a gas contained in the cavity 8, or any other suitable means capable of storing energy. In an alternative embodiment (not shown), a tension spring may be used arranged between and connected to the housing 7 of the non-return valve attachment 6 and the piston assembly, thus arranged on the side of the piston 9 facing the valve member 3. Thus, a tension spring is extended in contrast of a compression spring which is compressed in order to store energy. However, in the preferred embodiment a compression spring 11 is arranged between the piston 9 and a first end cover 12 of the housing 7 of the non-return valve attachment 6, which first end cover 12 is located remote from the valve member 3. When the piston assembly is in the first position of the piston assembly, it drives the valve member 3 towards the first position of the valve member 3 under the action of the energy storing means 11. Preferably, the valve member 3 is biased into said first position of the valve member 3 by means of the piston assembly positioned in said first position of the piston assembly, under the action of the energy storing means 11.

The function of the inventive non-return valve 1 will now be described. The ball valve member 3 is pushed towards the inlet opening 4 of the valve housing 2 by liquid pressure of the liquid present downstream of the non-return valve 1, and blocks the inlet opening 4, i.e. prevents a liquid flow in a first direction. Thereto, the rod 10 of the piston assembly abuts the ball valve member 3, preferably the rod 10 pushes the ball valve member 3 against the inlet opening 4 as mention above, in order to bias the valve member 3 into the first position of the valve member 3. When the pump is activated the flow of liquid displaces the ball valve member 3 away from the first position of the valve member 3, and at the same time the pumped liquid will act against the side of the piston 9 facing the valve member 3. The area of said side of the piston 9 and the energy storing means 11 shall be dimensioned such that normal fluid pressure of the pumped liquid upon operation of the pump is sufficient to displace the piston assembly away the first position of the piston assembly and towards the second position of the piston assembly. Furthermore, the area of said side of the piston 9 and the shape and orientation of the valve member 3 shall preferably be dimensioned such that the fluid pressure of the liquid acting against the piston 9 shall displace the piston assembly to the second position of the piston assembly such that the flow of the liquid may displace the valve member 3 from the first position to the second position of the valve member 3 without being obstructed by the piston assembly. It shall be pointed out that the fluid pressure of the liquid does more or less not at all effect the displacement of the valve member 3, since the same amount of fluid pressure acts on all sides of the valve member 3. Thus, the piston assembly shall be displaced away from the first position of the piston assembly, such that the valve member 3 may be pushed by the flow of the liquid into the second position of the valve member 3 without being obstructed by the rod 10 of the piston assembly. Further, the valve member 3 may at the second position abut the rod 10 of the piston assembly, but no force from the non-return valve attachment 6 shall act to displace the valve member 3 away from the second position of the valve member 3 during operation of the pump. Preferably, the piston assembly is biased into the second position of the piston assembly under the action of the fluid pressure of the pumped liquid.

Moreover, the non-return valve attachment 6 may comprise a diaphragm 13, which is peripherally in liquid sealing engagement with the housing 7 of the non-return valve attachment 6 and which is provided on the opposite side of the piston 9 in relation to the abovementioned cavity 8, the diaphragm 13 and the piston 9 defining a chamber 14, which is filled with a more or less incompressible fluid, upon normal operation of the pump and the non-return valve 1. In a preferred embodiment the diaphragm 13 is in liquid sealing engagement with the envelope surface of the rod 10, such that the rod 10 extends through the diaphragm 13. However, in an alternative embodiment (not shown) the diaphragm 13 may be undivided and situated between the end of the rod 10 of the piston assembly and the valve member 3. The function of the diaphragm 13 is to prevent the pumped liquid from entering the housing 7 of the non-return valve attachment 6 and reaching the piston 9 and the inner wall surface of said housing 7. The pumped liquid may contain solid matter and other contaminations that may impair the function of the non-return valve attachment 6. If a diaphragm 13 is used the fluid pressure of the pumped liquid acts against said diaphragm 13 and the force is transmitted via the incompressible fluid within the chamber 14 to the piston 9.

When the pump is turned off, it has been shown that the fluid pressure of the liquid in a piping system decreases more rapid than the flow direction of the liquid stops and reverses, approximately 10-20 times more rapid. Thus, when the pump is turned off the fluid pressure of the liquid will decrease to low values almost immediately, in extreme cases even reach vacuum, whereupon the stored energy in the energy storing means 11 starts to act to displace the piston assembly from the second position of the piston assembly towards the first position of the piston assembly. At the same time the rod 10 of the piston assembly drives the ball valve member 3 towards the first position of the valve member 3 with a higher force than conventional non-return valve attachments, thus trying to block the inlet opening 4 of the non-return valve 1 and at the same time slowing down the liquid speed by choking the flow of the liquid. Thus, the valve member 3 will take the first position of the valve member 3 just before or at the same time as the flow of the liquid stops, thus just before or at the same time as the flow of liquid in a conventional non-return valve should reverse. On the contrary you may say that the flow of the liquid upstreams of the non-return valve 1 stops at the same time as the valve member 3 takes the first position of the valve member 3. Accordingly, the generation of a vacuum pocket as mention above with reference to prior art is entirely eliminated.

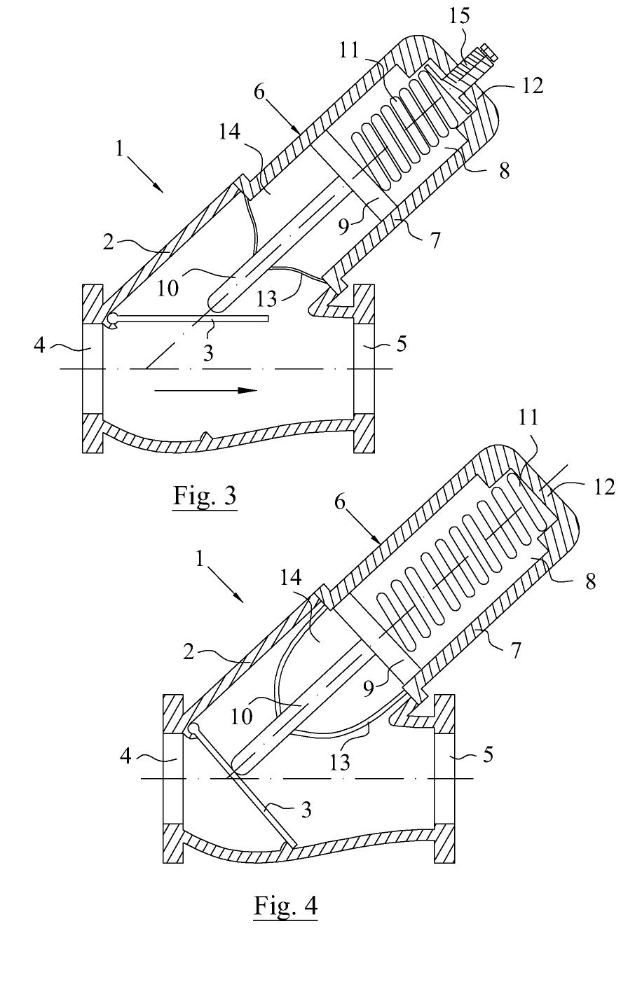

Reference is now made to FIGS. 3 and 4, which shows an alternative embodiment of the inventive non-return valve 1. The valve member 3 is constituted by a flap, which is pivotally connected to the valve housing 2. The non-return valve 1 according to FIGS. 3 and 4 has the same function as the non-return valve 1 according to FIGS. 1 and 2, and the flap valve member 3 is movable between a first position according to FIG. 4 and a second position according to FIG. 3.

In FIG. 3 is shown an adjustment device 15 in order to adjust the action of the energy storing means 11 to match different applications. The shown embodiment of the adjustment device 15 comprises a plate abutting the spring 11 and an externally threaded bar that can be screwed into and out of the cavity 8, in order to tighten or loosen the spring 11. A similar adjustment device may be used if the energy storing means 11 is a gas, e.g. the cavity 8 presents an adjustable volume.

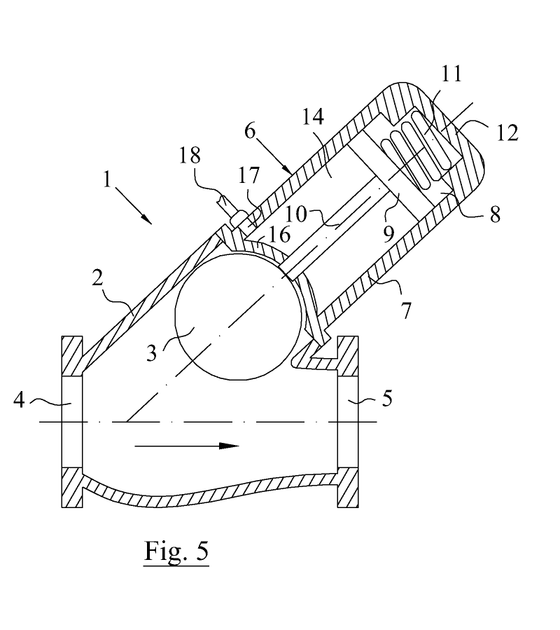

Reference is now made to FIG. 5, which shows another embodiment of the inventive non-return valve 1. In FIG. 5 the diaphragm is replaced by a second end cover 16 arranged adjacent to the valve member 3. The second end cover 16 is rigid and defines the abovementioned chamber 14 together with the housing 7 of the non-return valve attachment 6, and the piston 9. The second end cover 16 comprises an opening through which the rod 10 of the piston assembly is movable. The rod 10 is in liquid sealing engagement with the opening of the second end cover 16. Moreover, the non-return valve attachment 6 according to FIG. 5 comprises an opening 17 in the housing 7, which opening 17 mouths in the chamber 14 adjacent to the second end cover 16. A conduit 18 is connected to said opening 17, which conduit 18 in the other end is connected to an outlet pipe (not shown) extending between the pump and the non-return valve 1. Thus, the cavity 14 is in fluid communication with said outlet pipe and the pumped liquid enters the cavity 14 through the conduit 18 and acts on the piston 9. Since the conduit 18 has a smaller cross section volume than the outlet pipe between the pump and the non-return valve 1, a slower but still rapid enough response of the non-return valve attachment 6 is obtained.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the non-return valve may be modified in all kinds of ways within the scope of the appended claims.

For instance, it shall be pointed out that the valve member and the rod of the piston assembly may be connected to each other, instead of being two separate elements as in the shown embodiments, and being jointly movable between their respective first positions and second positions.

It shall also be pointed out that the term fluid pressure used refers primarily to the static pressure of the liquid, since the dynamic pressure varies considerably.

It should be pointed out that an advantage of the present invention is that, if the piston assembly due to incorrect mounting in the non-return valve, or due to something else, should jam when distanced from the first position of the piston assembly, the valve member of the non-return valve is free to work as an ordinary non-return valve until the non-return valve is replaced or repaired.

It shall also be pointed out that all information about/concerning terms such as above, below, under, upper, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

1.-15. (canceled)

16. A non-return valve for a liquid piping system, comprising a valve housing and a valve member, which valve housing defines a flow path for a liquid, the valve member being movable under the effect of the flow of said liquid between a first position, in which the flow path is blocked and a liquid flow in a first direction is prevented, and a second position, in which the flow path is un-blocked and a liquid flow in an opposite second direction is admitted, the non-return valve being equipped with a non-return valve attachment comprising a housing, a piston assembly, and an energy storing means, the piston assembly being axially movable in relation to said housing between a first position and a second position, wherein the piston assembly, in said first position, under the action of the energy storing means overcomes the fluid pressure of said liquid and drives the valve member towards said first position of the valve member, and in said second position the fluid pressure of said liquid drives the piston assembly against the action of the energy storing means away from said first position of the piston assembly, such that the valve member is movable into said second position of the valve member.

17. The non-return valve according to claim 16, wherein the valve member is biased into said first position of the valve member by means of the piston assembly positioned in said first position of the piston assembly, under the action of the energy storing means.

18. The non-return valve according to claim 16, wherein the piston assembly is biased into said second position of the piston assembly under the action of the fluid pressure of the liquid.

19. The non-return valve according to claim 16, wherein the piston assembly comprises a piston and a rod, the piston and the house of the piston assembly defining a cavity, the rod extending from said piston away from said cavity and towards the valve member.

20. The non-return valve according to claim 19, wherein the piston assembly comprises a diaphragm, which is in liquid sealing engagement with the housing of the non-return valve attachment and which is provided on the opposite side of the piston in relation to said cavity, the diaphragm, said housing and the piston defining a chamber, which is filled with an incompressible fluid.

21. The non-return valve according to claim 20, wherein the diaphragm is in liquid sealing engagement with the envelope surface of the rod.

22. The non-return valve according to claim 16, wherein the valve member is a ball.

23. The non-return valve according to claim 22, wherein the ball valve member is freely movable and guided by guide means between said first and said second position of the valve member.

24. The non-return valve according to claim 22, wherein the ball valve member is connected to the piston assembly, which are jointly movable between their respective first positions and second positions.

25. The non-return valve according to claim 16, wherein the valve member is a flap.

26. The non-return valve according to claim 25, wherein the flap valve member is pivotally connected to the valve housing.

27. The non-return valve according to claim 16, wherein the energy storing means is a compression spring.

28. The non-return valve according to claim 16, wherein the energy storing means is a gas.

29. The non-return valve according to claim 16, wherein the action of the energy storing means is adjustable.

30. The non-return valve according to claim 19, wherein the non-return valve attachment comprises a second end cover having a through hole that is in liquid sealing engagement with the rod of the piston assembly, the non-return valve comprising a conduit extending from a chamber, defined by the piston, the housing of the non-return valve attachment and the second end cover, and connectable to an outlet pipe extending between a pump and said non-return valve.
